(19) United States
(12) Patent Application Publication
(10) Pub. No.: US 2026/0119583 A1
(43) Pub. Date: Apr. 30, 2026

(54) REDUCTION OF DUPLICATES FROM SEMI-JOIN REDUCTION OPERATIONS

(71) Applicant: SAP SE, Walldorf (DE)

(72) Inventors: Sukhyeun Cho, Incheon (KR); Sumin Ko, Incheon (KR)

(21) Appl. No.: 18/932,439

(22) Filed: Oct. 30, 2024

(51) Int. Cl. G06F 16/903

(52) U.S. Cl. CPC G06F 16/90335

(57) ABSTRACT

Arrangements for reduction of duplicates from semi-join reduction operations are provided. A query subplan appearing multiple times in a search space of a query plan may be identified. A semi-join reduction operation may be applied to a top join of a first subplan, and a new transparent view may be generated. The newly generated transparent view may be stored in a cache as a right child node of a semi-join. A join through join operation may be applied to multiple semi-joins from the semi-join reduction operation. The semi-join reduction operation may be applied to a top join of a second subplan, reusing the transparent view stored in the cache. While applying the join through join operation on a new semi-join, another semi-join having same children nodes, a same join condition, and a same join type may be detected. The new semi-join may be replaced with an already-enumerated semi-join.

### TECHNICAL FIELD

The subject matter described herein relates generally to data processing and, in particular, to reduction of duplicates from semi-join reduction operations.

### BACKGROUND

Oftentimes there could be multiple semi-joins from semi-join reduction operations sharing a common reducer. Additionally, semi-joins can be a target of logical and physical enumeration. However, since a transparent view for the reducer of a semi-join, which allows the reducer to be shared by the original join and the semi-join, is always newly created and inserted between the joins and the reducer, which means it is considered a different view in the optimizer, database systems are unable to detect duplicates for the semi-joins. This leads to duplicate enumeration steps for each semi-join, causing an increase in compilation time.

### SUMMARY

Methods, systems, and articles of manufacture, including computer program products, are provided for reduction of duplicates from semi-join reduction operations are implemented. In one aspect, a computer-implemented method includes identifying a query subplan appearing multiple times in a search space of a query plan; applying a semi-join reduction operation to a top join of a first subplan, wherein applying the semi-join reduction operation to the top join of the first subplan includes newly generating a transparent view; storing the newly generated transparent view in a cache, wherein the newly generated transparent view is a right child node of a semi-join; applying a join through join operation to multiple semi-joins from the semi-join reduction operation; applying the semi-join reduction operation to a top join of a second subplan, wherein applying the semi-join reduction operation to the top join of the second subplan comprises reusing the transparent view stored in the cache; detecting, while applying the join through join operation on a new semi-join, another semi-join having same children nodes, a same join condition, and a same join type; and replacing the new semi-join with an already-enumerated semi-join from a join cache.

In some variations one or more of the following can optionally be included. The semi-join reduction operation applies joins multiple times in the query plan. The top join includes an inner join, a left-outer join, a right-outer join, or full-outer join. The semi-join is a relational algebra operation that selects tuples from one relation that matches tuples in another relation. Reusing the transparent view stored in the cache includes skipping partition calculations for the transparent view. The join through join operation changes a join order for a query. The computer-implemented method may be implemented in a distributed database environment.

Articles are also described that comprise a tangibly embodied machine-readable medium operable to cause one or more machines (e.g., computers, etc.) to result in operations described herein. Similarly, computer systems are also described that may include a processor and a memory coupled to the processor. The memory may include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a graph illustrating a query subplan appearing multiple times in a search space of a query plan in accordance with some example embodiments;

FIG. 2 depicts a graph illustrating caching a newly added transparent view in accordance with some example embodiments;

FIG. 3 depicts a graph illustrating application of join through join operations in accordance with some example embodiments;

FIG. 4 depicts a graph illustrating a reduction of duplicates from semi-join reduction operations in accordance with some example embodiments;

FIG. 5 depicts a flowchart illustrating a process for implementing reduction of duplicates from semi-join reduction operations in accordance with some example embodiments; and

FIG. 6 depicts a block diagram illustrating a computing system, in accordance with some example embodiments.

When practical, similar reference numbers denote similar structures, features, or elements.

### DETAILED DESCRIPTION

Aspects of the disclosure provide a technical solution that addresses problems associated with the reduction of duplicates from semi-join reduction operations. For example, aspects of the disclosure caches a transparent view of a semi-join from a semi-join reduction operation. The cached transparent view replaces other transparent views sharing the same child to avoid repeated enumeration for the view and the semi-join holding it as its reducer child, leading to the reduction of compilation time.

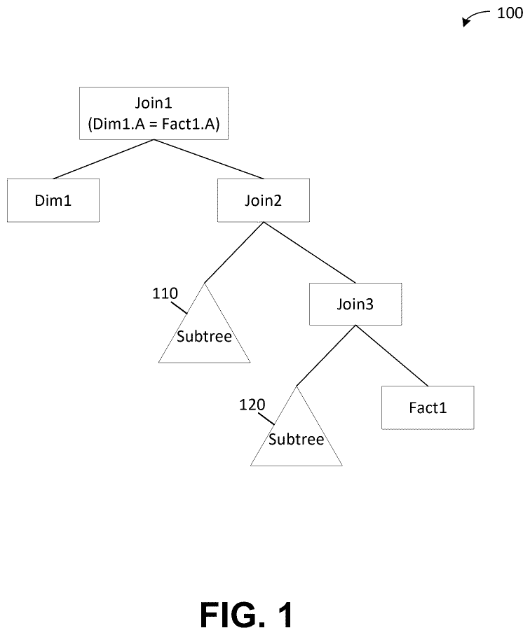

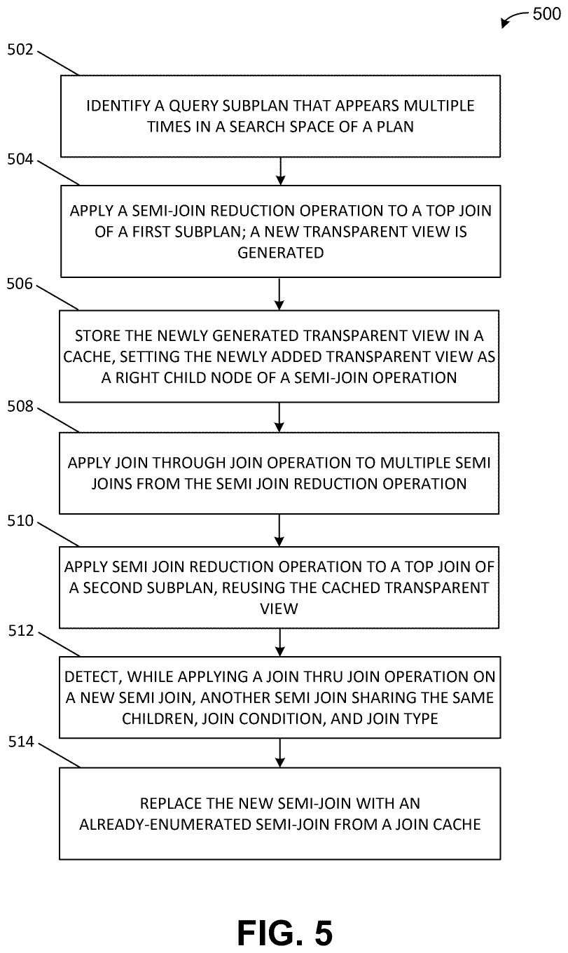

FIGS. 1-4 depict various graphs associated with implementing reduction of duplicates from semi-join reduction operations in accordance with some example embodiments. FIG. 5 depicts a flowchart 500 illustrating a process for implementing reduction of duplicates from semi-join reduction operations in accordance with some example embodiments. FIG. 5 will be discussed together with FIGS. 1 through 4.

Referring to FIG. 5, at step 502, a computing platform (e.g., optimizer) may identify (e.g., during plan enumeration) a query subplan that appears multiple times (e.g., two or more) in a search space of a query plan (or query execution plan). In this regard, FIG. 1 depicts a graph 100 illustrating a query subplan appearing multiple times in a search space of a query plan in accordance with some example embodiments. A subtree having different ancestor sets can appear multiple times in a query plan (e.g., subtree 110, 120). A query plan is often represented as a tree, where the internal nodes are operators, the leaves are input relations, and the edges show data flow. Plan enumeration may be used for query optimization in database systems that involve finding the optimal way to execute a query. A plan enumeration algorithm may find the best (e.g., optimal) join order from a set of semantically equivalent join orders for a query to minimize costs.

In one example, as shown in FIG. 1, a target side (e.g., right side of the graph) may have a large amount of data (numerous rows (e.g., 100 million rows)) and a reducer side (e.g., left side of the graph) may have much less data (only a few rows (e.g., 10 rows)). The target side may include a fact table producing a numerous amount of data. Reducers may be used to reduce the size of the target side before executing the original join. Reducers may filter out results from the target, which are unmatched to any of its output rows.

Returning to FIG. 5, at step 504, the computing platform may apply a semi-join reduction operation to a top join of a first subplan. Applying the semi-join reduction operation to the top join of the first subplan may include generating a new transparent view (e.g., transparent view 220, 222). The semi-join is a relational algebra operation that selects tuples from one relation that matches tuples in another relation. For example, a semi-join may filter out rows from the target child which do not match any of the rows from the reducer child. A semi-join reduction operation is an optimization technique used to handle joins more effectively. The semi-join reduction operation may apply joins multiple times in the query plan.

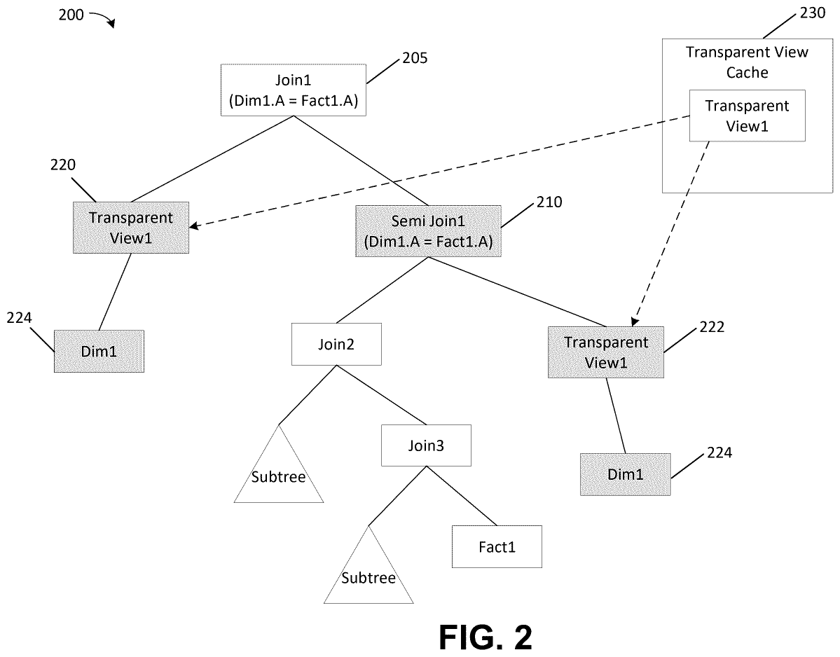

In this regard, FIG. 2 depicts a graph 200 illustrating caching a newly added transparent view in accordance with some example embodiment. As shown in FIG. 2, the semi-join reduction operation is applied to the top join 205 of a first subplan. A semi-join 210 may be inserted into the target side of the join 205. The same join condition 205 may be passed to the semi-join 210. The semi-join 210 can filter the results from the target side before executing the join 205 using the rows from the reducer side. The rows are matched from the rows from the reducer side (e.g., Dim1, left child node of the join in FIG. 2) before executing the original join 205. In a distributed database environment, one side may be located in a first server (server 1) and another side may be located in another server (server 2). The semi-join reduction operation reduces the size of the target side at server 1, only transferring the filtered rows from the target side to server 2 where the original join is executed.

When applying the semi-join reduction operation, the computing platform may insert a transparent view 222 on the reducer side of the original join 205. The join and the semi-join will then share a common child node (Dim1, 224). As shown in FIG. 2, the reducer side of the original join becomes the right child node of the newly created semi-join from the semi-join reduction operation. Instead of copying the reducer (Dim1) for the newly created semi-join, aspects of the disclosure may insert a transparent view 220 between the join (205) and Dim1 (224) and a transparent view 222 between Semi-Join1 (210) and Dim1 (224). The transparent view may share a common child node (Dim1, 224 in FIG. 2) and pass all the data from the child node. Advantageously, instead of copying Dim1 for the newly created semi-join 210, a transparent view 222 is inserted and the same Dim1, 224 may be used without copying data. Hence, the transparent view propagates data from its child node instead of materializing the data from its child node.

Referring to FIG. 5, at step 506, the computing platform may store the newly generated transparent view in a cache using its child address as a cache key. The newly generated transparent view may be a right child node of a semi-join. As shown in FIG. 2, a new transparent view 222 is created. The newly added transparent view 222 may be set (e.g., in transparent view cache 230) as the right child node of the semi-join 210 from the semi-join reduction operation. In some embodiments, transparent views sharing a common child node is treated as the same transparent view (e.g., transparent view 220 and transparent view 222). In such a case, the cache key is the address of the child node operator of a transparent view. The cached transparent view may be used whenever a transparent view having a common child node is requested. During enumeration steps, because the cached transparent view may be reused, its partition information or other details need only be calculated once. Reusing the transparent view stored in the cache may include skipping various enumeration processes during the compilation of a query, such as addition of logical/physical alternatives, size and cost estimation, and partition calculations for the transparent view.

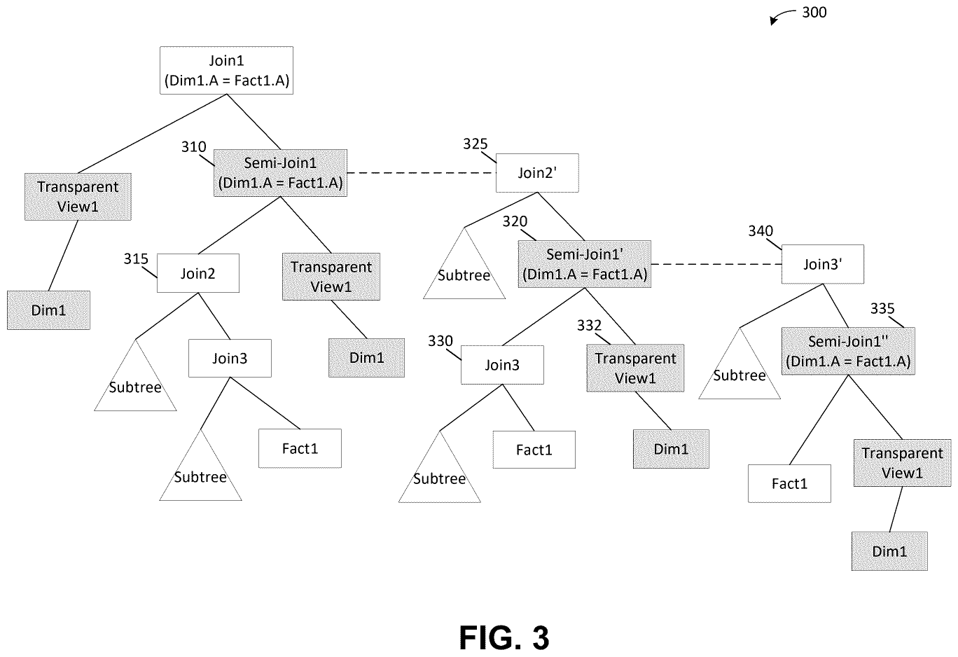

Referring to FIG. 5, at step 508, the computing platform may apply a join through join operation to multiple semi-joins from the semi-join reduction operation. The join through join operation changes a join order for a query. In this regard, FIG. 3 depicts a graph 300 illustrating application of join through join operations in accordance with some example embodiments. As shown in FIG. 3, a join through join operation is applied multiple times to the Semi-Join1 from the semi-join reduction operation to find an optimal plan.

In FIG. 3, for Semi-Join1 310, the join through join operation is applied so that the order of Semi-Join1 (310) and Join2 (315) is changed as shown in Semi-Join1′ (320) and Join2′ (325). And again, between Semi-Join1′ (320) and Join3 (330), the same join through join operation is applied so the order of Semi-Join1′ (320) and Join3 (330) is changed as shown in Semi-Join1″ (335) and Join3′ (340). Semi-Join1″ (335) is inserted below Join3′ (340). The original children from Semi-Join1″(335) and Join3′ (340) are maintained.

Further, as shown in FIG. 3, a join through join operation is applied to Semi-Join1 310, and Join2′ 325 is registered as the logical alternative of Semi-Join1 310. For Semi-Join1′ 320, produced by the join through join operation on Semi-Join1 310, another join through join operation can be applied and the rightmost Join3′ 340 can be registered as the logical alternative of Semi-Join1′ 320. In FIG. 3, various transformations can be applied to Semi-Join1 310, leading to the increase in compilation time, as a lot of logical and physical alternatives of the newly created operators need to be built. Aspects of the disclosure address this technical problem.

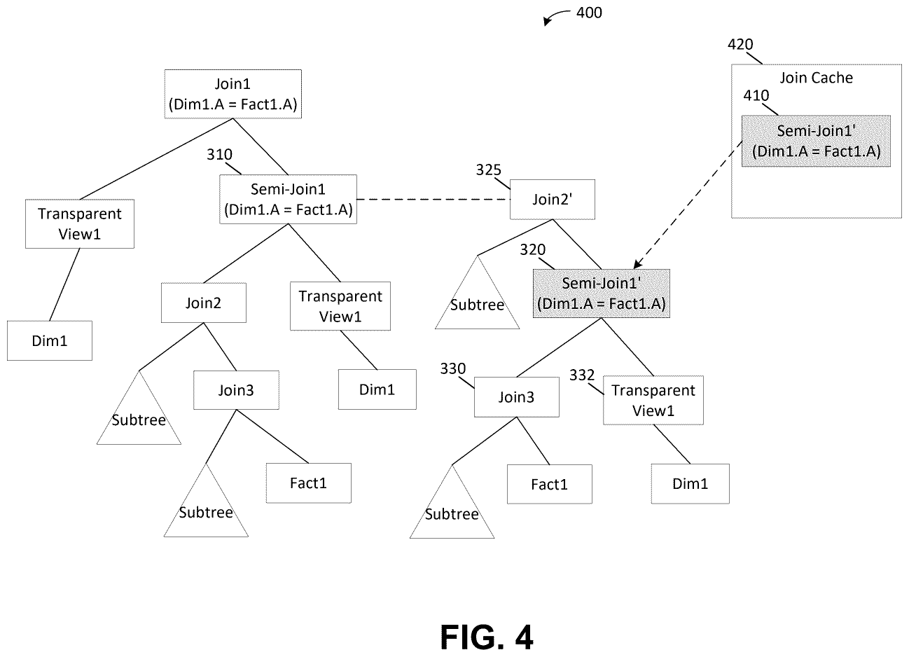

Returning to FIG. 5, at step 510, the computing platform may apply the semi-join reduction operation to a top join of a second subplan (e.g., Join2 in FIG. 3). In some examples, applying the semi-join reduction operation to the top join of the second subplan may include reusing the transparent view stored in the cache. Instead of creating a new transparent view, the already cached transparent view (e.g., in FIG. 2) may be used when transparent views share a common child. In this regard, FIG. 4 depicts a graph 400 illustrating a reduction of duplicates from semi-join reduction operations in accordance with some example embodiments. As shown in FIG. 4, Semi-Join1′ is already cached in join cache 420 (e.g., from Semi-Join1′ 320). Since the cached transparent view (e.g., Transparent View1 in FIG. 2) is reused for the newly created semi-join from semi-join reduction operation, it can be concluded that Semi-Join1′ 320 and Semi-Join1′ 410 share common children, join condition, and join type, as the newly created semi-join, Semi-Join1′ 320 gets its right child from the transparent view cache, more specifically, the cached Transparent View1 (in FIG. 2). By reusing the cached transparent view, aspects of the disclosure may skip repeated calculation and physical enumeration on the transparent view. Additionally, repeated logical transformations and physical algorithm decisions and other things on the semi-join may be skipped, as the cached Semi-Join1′ 410 already has necessary information. This can lead to reduction in the compilation time.

At step 512, the computing platform may detect, while applying the join through join operation on a new semi-join, another semi-join having same children nodes, a same join condition, and a same join type (e.g., inner join, outer join, semi-join, and other join operation types). At step 514, the computing platform may replace the new semi-join with an already-enumerated semi-join (e.g., Semi-Join1′ 410) from a join cache (e.g., join cache 420).

Instead of applying join through join again or applying other logical optimizations or physical enumerations on the semi-join (e.g., at 320 in FIG. 3), it may be detected that Semi-Join1′ (320 in FIG. 4) holding Join 3 (330) and Transparent View1 (332) has already previously appeared in the search space. Therefore, the Semi-Join1′ 320 can be replaced with an already enumerated one (e.g., 410 in FIG. 4). Therefore, aspects of the disclosure skips applying additional rules on Semi-Join1′ (e.g., 320 in FIG. 4). Instead, a transparent view which is already enumerated (e.g., Transparent View1 332) may be reused. And, Semi-Join1′ 320 may be replaced with an already enumerated semi-join (e.g., Semi-Join1′ 410). Advantageously, partition calculations or cost calculations for the transparent view and the semi-join may be skipped, leading to the reduction of compilation time.

Advantageously, many logical operator creating steps may be skipped for the reducer side of a semi-join, with the optimizer creating the reducer only once, and then using the cached one for other enumeration attempts in various locations of a search space tree. This includes partition calculations, memory allocation for data structures of the relation, and so forth. Moreover, by using cached reducers, more operators having cached reducers as their children are evaluated as duplicates and replaced by pre-enumerated ones that have successfully passed logical and physical enumeration steps, leading to a reduction in compilation time.

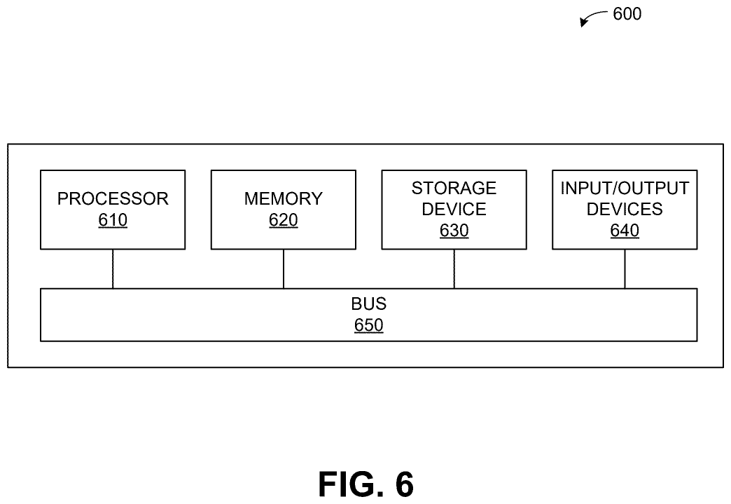

FIG. 6 depicts a block diagram illustrating a computing system 600 consistent with implementations of the current subject matter. Referring to FIGS. 1-6, the computing system 600 can be used to implement reduction of duplicates from semi-join reduction operations 500 and/or any components therein.

As shown in FIG. 6, the computing system 600 can include a processor 610, a memory 620, a storage device 630, and input/output devices 640. The processor 610, the memory 620, the storage device 630, and the input/output devices 640 can be interconnected via a system bus 650. The processor 610 is capable of processing instructions for execution within the computing system 600. Such executed instructions can implement one or more components of, for example, reduction of duplicates from semi-join reduction operations 500. In some implementations of the current subject matter, the processor 610 can be a single-threaded processor. Alternately, the processor 610 can be a multi-threaded processor. The processor 610 is capable of processing instructions stored in the memory 620 and/or on the storage device 630 to display graphical information for a user interface provided via the input/output device 640.

The memory 620 is a computer readable medium such as volatile or non-volatile that stores information within the computing system 600. The memory 620 can store data structures representing configuration object databases, for example. The storage device 630 is capable of providing persistent storage for the computing system 600. The storage device 630 can be a solid-state device, a floppy disk device, a hard disk device, an optical disk device, a tape device, and/or any other suitable persistent storage means. The input/output device 640 provides input/output operations for the computing system 600. In some implementations of the current subject matter, the input/output device 640 includes a keyboard and/or pointing device. In various implementations, the input/output device 640 includes a display unit for displaying graphical user interfaces.

According to some implementations of the current subject matter, the input/output device 640 can provide input/output operations for a network device. For example, the input/output device 640 can include Ethernet ports or other networking ports to communicate with one or more wired and/or wireless networks (e.g., a local area network (LAN), a wide area network (WAN), the Internet).

In some implementations of the current subject matter, the computing system 600 can be used to execute various interactive computer software applications that can be used for organization, analysis and/or storage of data in various (e.g., tabular) format (e.g., Microsoft Excel®, and/or any other type of software). Alternatively, the computing system 600 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities (e.g., SAP Integrated Business Planning add-in for Microsoft Excel as part of the SAP Business Suite, as provided by SAP SE, Walldorf, Germany) or can be standalone computing products and/or functionalities. Upon activation within the applications, the functionalities can be used to generate the user interface provided via the input/output device 640. The user interface can be generated and presented to a user by the computing system 600 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well.

For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A computer-implemented method comprising:
identifying a query subplan appearing multiple times in a search space of a query plan;
applying a semi-join reduction operation to a top join of a first subplan, wherein applying the semi-join reduction operation to the top join of the first subplan includes newly generating a transparent view;
storing the newly generated transparent view in a cache, wherein the newly generated transparent view is a right child node of a semi-join;
applying a join through join operation to multiple semi-joins from the semi-join reduction operation;
applying the semi-join reduction operation to a top join of a second subplan, wherein applying the semi-join reduction operation to the top join of the second subplan comprises reusing the transparent view stored in the cache;
detecting, while applying the join through join operation on a new semi-join, another semi-join having same children nodes, a same join condition, and a same join type; and
replacing the new semi-join with an already-enumerated semi-join from a join cache.

Example 2: The computer-implemented method of Example 1, wherein the semi-join reduction operation applies joins multiple times in the query plan.

Example 3: The computer-implemented method of any of Examples 1-2, wherein the top join comprises an inner join, a left-outer join, a right-outer join, or a full-outer join.

Example 4: The computer-implemented method of any of Examples 1-3, wherein the semi-join is a relational algebra operation that selects tuples from one relation that matches tuples in another relation.

Example 5: The computer-implemented of any of Examples 1-4, wherein reusing the transparent view stored in the cache comprises skipping partition calculations for the transparent view.

Example 6: The computer-implemented of any of Examples 1-5, wherein the join through join operation changes a join order for a query.

Example 7: The computer-implemented of any of Examples 1-6, wherein the computer-implemented method is implemented in a distributed database environment.

Example 8: A system comprising:
at least one processor; and
at least one memory including program code which when executed causes the system to provide operations comprising:
identifying a query subplan appearing multiple times in a search space of a query plan;
   applying a semi-join reduction operation to a top join of a first subplan, wherein applying the semi-join reduction operation to the top join of the first subplan includes newly generating a transparent view;
   storing the newly generated transparent view in a cache, wherein the newly generated transparent view is a right child node of a semi-join;
   applying a join through join operation to multiple semi-joins from the semi-join reduction operation;
   applying the semi-join reduction operation to a top join of a second subplan, wherein applying the semi-join reduction operation to the top join of the second subplan comprises reusing the transparent view stored in the cache;
   detecting, while applying the join through join operation on a new semi-join, another semi-join having same children nodes, a same join condition, and a same join type; and
   replacing the new semi-join with an already-enumerated semi-join from a join cache.

Example 9: The system of Example 8, further comprising: wherein the semi-join reduction operation applies joins multiple times in the query plan.

Example 10: The system of any of Examples 8-9, wherein the top join comprises an inner join, a left-outer join, a right-outer join, or a full-outer join.

Example 11: The system of any of Examples 8-10, wherein the semi-join is a relational algebra operation that selects tuples from one relation that matches tuples in another relation.

Example 12: The system of any of Examples 8-11, wherein reusing the transparent view stored in the cache comprises skipping partition calculations for the transparent view.

Example 13: The system of any of Examples 8-12, wherein the join through join operation changes a join order for a query.

Example 14: The system of any of Examples 8-13, wherein the system comprises a distributed database environment.

Example 15: A non-transitory computer-readable storage medium including program code which when executed by at least one processor causes operations comprising:
identifying a query subplan appearing multiple times in a search space of a query plan;
applying a semi-join reduction operation to a top join of a first subplan, wherein applying the semi-join reduction operation to the top join of the first subplan includes newly generating a transparent view;
storing the newly generated transparent view in a cache, wherein the newly generated transparent view is a right child node of a semi-join;
applying a join through join operation to multiple semi-joins from the semi-join reduction operation;
applying the semi-join reduction operation to a top join of a second subplan, wherein applying the semi-join reduction operation to the top join of the second subplan comprises reusing the transparent view stored in the cache;
detecting, while applying the join through join operation on a new semi-join, another semi-join having same children nodes, a same join condition, and a same join type; and
replacing the new semi-join with an already-enumerated semi-join from a join cache.

Example 16: The non-transitory computer-readable storage medium of Example 15, wherein the semi-join reduction operation applies joins multiple times in the query plan.

Example 17: The non-transitory computer-readable storage medium of Example 15-16, wherein the top join comprises an inner join, a left-outer join, a right-outer join, or a full-outer join.

Example 18: The non-transitory computer-readable storage medium of Example 15-17, wherein the semi-join is a relational algebra operation that selects tuples from one relation that matches tuples in another relation.

Example 19: The non-transitory computer-readable storage medium of Example 15-18, wherein reusing the transparent view stored in the cache comprises skipping partition calculations for the transparent view.

Example 20: The non-transitory computer-readable storage medium of Example 15-19, wherein the join through join operation changes a join order for a query.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

1. A computer-implemented method comprising:
identifying a query subplan appearing multiple times in a search space of a query plan;
applying a semi-join reduction operation to a top join of a first subplan, wherein applying the semi-join reduction operation to the top join of the first subplan includes newly generating a transparent view;
storing the newly generated transparent view in a cache, wherein the newly generated transparent view is a right child node of a semi-join;
applying a join through join operation to multiple semi-joins from the semi-join reduction operation;
applying the semi-join reduction operation to a top join of a second subplan, wherein applying the semi-join reduction operation to the top join of the second subplan comprises reusing the transparent view stored in the cache;
detecting, while applying the join through join operation on a new semi-join, another semi-join having same children nodes, a same join condition, and a same join type; and
replacing the new semi-join with an already-enumerated semi-join from a join cache.

2. The computer-implemented method of claim 1, wherein the semi-join reduction operation applies joins multiple times in the query plan.

3. The computer-implemented method of claim 1, wherein the top join comprises an inner join, a left-outer join, a right-outer join, or a full-outer join.

4. The computer-implemented method of claim 1, wherein the semi-join is a relational algebra operation that selects tuples from one relation that matches tuples in another relation.

5. The computer-implemented method of claim 1, wherein reusing the transparent view stored in the cache comprises skipping partition calculations for the transparent view.

6. The computer-implemented method of claim 1, wherein the join through join operation changes a join order for a query.

7. The computer-implemented method of claim 1, wherein the computer-implemented method is implemented in a distributed database environment.

8. A system comprising:
at least one processor; and
at least one memory including program code which when executed causes the system to provide operations comprising:
identifying a query subplan appearing multiple times in a search space of a query plan;
applying a semi-join reduction operation to a top join of a first subplan, wherein applying the semi-join reduction operation to the top join of the first subplan includes newly generating a transparent view;
storing the newly generated transparent view in a cache, wherein the newly generated transparent view is a right child node of a semi-join;
applying a join through join operation to multiple semi-joins from the semi-join reduction operation;
applying the semi-join reduction operation to a top join of a second subplan, wherein applying the semi-join reduction operation to the top join of the second subplan comprises reusing the transparent view stored in the cache;
detecting, while applying the join through join operation on a new semi-join, another semi-join having same children nodes, a same join condition, and a same join type; and
replacing the new semi-join with an already-enumerated semi-join from a join cache.

9. The system of claim 8, wherein the semi-join reduction operation applies joins multiple times in the query plan.

10. The system of claim 8, wherein the top join comprises an inner join, a outer join, a right-outer join, or a full-outer join.

11. The system of claim 8, wherein the semi-join is a relational algebra operation that selects tuples from one relation that matches tuples in another relation.

12. The system of claim 8, wherein reusing the transparent view stored in the cache comprises skipping partition calculations for the transparent view.

13. The system of claim 8, wherein the join through join operation changes a join order for a query.

14. The system of claim 8, wherein the system comprises a distributed database environment.

15. A non-transitory computer-readable storage medium including program code which when executed by at least one processor causes operations comprising:
identifying a query subplan appearing multiple times in a search space of a query plan;
applying a semi-join reduction operation to a top join of a first subplan, wherein applying the semi-join reduction operation to the top join of the first subplan includes newly generating a transparent view;
storing the newly generated transparent view in a cache, wherein the newly generated transparent view is a right child node of a semi-join;
applying a join through join operation to multiple semi-joins from the semi-join reduction operation;
applying the semi-join reduction operation to a top join of a second subplan, wherein applying the semi-join reduction operation to the top join of the second subplan comprises reusing the transparent view stored in the cache;
detecting, while applying the join through join operation on a new semi-join, another semi-join having same children nodes, a same join condition, and a same join type; and
replacing the new semi-join with an already-enumerated semi-join from a join cache.

16. The non-transitory computer-readable storage medium of claim 15, wherein the semi-join reduction operation applies joins multiple times in the query plan.

17. The non-transitory computer-readable storage medium of claim 15, wherein the top join comprises an inner join, a left-outer join, a right-outer join, or full-outer join.

18. The non-transitory computer-readable storage medium of claim 15, wherein the semi-join is a relational algebra operation that selects tuples from one relation that matches tuples in another relation.

19. The non-transitory computer-readable storage medium of claim 15, wherein reusing the transparent view stored in the cache comprises skipping partition calculations for the transparent view.

20. The non-transitory computer-readable storage medium of claim 15, wherein the join through join operation changes a join order for a query.
